(19) United States
(12) Patent Application Publication
(10) Pub. No.: US 2010/0023159 A1
(43) Pub. Date: Jan. 28, 2010

(54) PALLETING DEVICE AND A PROCESSING SYSTEM WITH SUCH DEVICE

(75) Inventor: Holger Mueller, Taucha (DE)

Correspondence Address: RANKIN, HILL & CLARK LLP, 38210 Glenn Avenue, WILLOUGHBY, OH, 44094-7808, US

(73) Assignee: FERAG AG, Hinwil (CH)

(21) Appl. No.: 12/508,766

(22) Filed: Jul. 24, 2009

(30) Foreign Application Priority Data
Jul. 24, 2008 (CH) 01155/08

(51) Int. Cl. B65G 1/04; G06F 7/00

(52) U.S. Cl. 700/217; 414/799

(57) ABSTRACT

A palleting device (10) is provided for the transport of units (1) of printed products which are held together by way of strapping, in particular of stacks formed from printed products rowed on one another in a standing manner or packages of printed products applied on one another in a lying manner. The palleting device (10) includes a carrier construction (11) with at least one vertically and horizontally displaceable holding element (14) which is capable of taking at least one printed product unit (1) from the intermediate deposit (50) and transporting it to the palleting position (10). The carrier construction (11) in a plan view from above on the working base surface (20) is arranged essentially within the working base surface (20) and/or in a first side region (30) outside the working base surface (20), wherein at least one second side region (40) of the working base surface (20) is free of the carrier construction (11). An unhindered access to the working base surface (20) from the other end is possible by way of this single-sided support and mounting of the holding elements (14). This has advantages with the maintenance, as well as for the feed transport and transport away of unloaded and loaded pallets.

### BACKGROUND OF THE INVENTION

1. Field of the Invention

The invention relates to the field of processing and conveying printed products, in particular printed product units, which are grouped together into a largely stable formation by way of strapping. Such units are e.g. stacks which are formed from standing printed products which are rowed on one another, or packages which consist of printed products applied on one another in a stack-like manner. The invention relates to a palleting device for the transport of such units from the exit, for example, of a stack formation device, to a pallet, on which they are deposited next to one another and on one another for the purpose of a further transport. The invention further relates to a processing system with a device for grouping together and strapping printed products, as well as with such a palleting device.

2. Description of Related Art

Different automatic palleting devices for stacking stacks or other units of printed products are known from the state of the art, e.g. EP-A 0 310 998, U.S. Pat. No. 4,419,035 or EP-A 1 378 472. These units, as a rule, are received by an intermediate deposit, which is located at the exit of a stack feeder or other device for grouping together the products. According to EP-A 1 378 472, the stacks are received directly from the position in which the stack is formed, i.e. without prior displacement of the stack transversely to its longitudinal direction. A gripper system with two or more holding elements, e.g. a pincer, is applied for transport to a palleting position, in which a pallet is located. For reasons of stability, this gripper system is mounted on a stationary frame, which is designed in the manner of a portal or bridge. With all known devices, it comprises two parallel, horizontal runner rails which are distanced from the base by about the height of a man, by way of four carrier columns, and between which a transverse beam is arranged in a displaceable manner in the rail direction. The actual gripper system is located on the transverse beam and is height-adjustable relative to the transverse beam.

The disadvantage with the known device is the fact that the access to the stack feeder or the correspondingly applied device for grouping together the units is blocked by the palleting device. This is because the frame for displacing the gripped unit necessarily has a width which is significantly larger than a typical stack length of approx. 1 m to 1.50 m, as well as a length which is significantly larger than a pallet width. The intermediate rest or the rest, on which the stacks or other units are formed, is therefore very difficultly accessible for repair and maintenance purposes, and a very large spatial requirement simultaneously results laterally and to the top. The pallets are difficult to feed and lead away due to this.

### BRIEF SUMMARY OF THE INVENTION

It is therefore the object of the invention to overcome the mentioned disadvantages and to provide a palleting device as well as a corresponding processing system, which permits an improved accessibility of the stack feeder or the device applied for forming the units, and well as a simpler feed-transport and away-transport of the unloaded and loaded pallets.

The palleting device according to the invention serves for the transport of units of printed products held together by way of strapping, within a working base surface, from an intermediate rest to a palleting position. It comprises a carrier construction with at least one vertically and horizontally displaceable holding element, which is capable of taking at least one printed product from the intermediate deposit and transporting it to the palleting position. According to the invention, the carrier construction, in a view from above, onto the working base surface is arranged at the most within the working base surface and in a first side region outside the working base surface, wherein at least one second side region of the working base surface is free of the carrier construction. The carrier construction of the palleting device, according to the invention, is thus located in the manner of a crane with a lateral overhang above and/or at one side of the working base surface. An unhindered access to the working base surface from the other side is made possible due to this one-sided support and mounting of the holding elements. This has advantages with the maintenance as well as for the feed-transport and away-transport of unloaded and loaded pallets, as well as possibly present storage (deposit table) for intermediate bases.

Working base surface, (in a view from above) meaning that base surface, within which product units are gripped by the displaceable holding elements and may be moved. It is therefore the case of the surface, which is covered by the gripped product units, the holding element or elements, or a movable carrier arm of the carrier construction. The intermediate rest is arranged at least partly, and the palleting position completely, within the working base surface. Moreover, further mobile or stationary elements may be arranged within the working base surface, e.g. a carriage, on which flat packaging material is located, which as an intermediate base, is often used for separating the individual layers from product units on the pallet. The intermediate deposit may be located outside the unit formation device, wherein the product units may then be displaced from the location of their manufacture to the intermediate deposit. It may also be a rest surface within such a device, wherein the products units in this case are received directly from the location of their manufacture.

Side regions of the working base surface are to be understood as those regions which border these in a plan view of the working base surface. According to the invention, there are two side regions which may be differentiated from one another, specifically a first side region in which the carrier construction is located or mounted or anchored, and a second side region in which or above which no part of the carrier construction, and also no other stationary element, such as e.g. the device for unit formation, is located. The second side region preferably has a width which corresponds at least to the width of a pallet transverse to its transport direction. Preferably it is even wider, in order to ensure a free access to the intermediate deposit or even to the device for unit formation (e.g. stack feeder).

In contrast to the state of the art, here, instead of a portal design with carrier columns arranged at opposite sides of the working base surface, in particularly at its four corners, and which accommodate the weight force of the carrier construction and of the received product units in a symmetric manner, a single-sided carrier construction with one or more overhanging carrier elements is suggested. This is capable of receiving and moving the product units with the working base surface. Despite this, the working surface remains accessible from the other side at least on regions without any height limitation. The arrangement of the carrier construction which is asymmetrical with respect to the working base surface, leads to asymmetric forces. The arising torques may be accommodated by a suitable design of the carrier construction, e.g. by way of transverse beams close to the base, and/or by way of their anchoring in the base and/or in the device for unit formation.

The working base surface or the stack feeder itself is better accessible for repair or maintenance purposes, in particular without height limitation or elements close to the base, by way of the carrier construction being arranged in only one of the side regions of the working base surface, and the other side region remaining free. Moreover, the loaded pallet may be transported away in a simple manner and with more room for play, without parts of the carrier construction blocking or inhibiting the transport path. Even with a carrier construction close to the ground, it is possible to feed the empty pallets which have a low height, in the first side region below the carrier construction which is distanced from the base in regions, in a pallet conveyor device, and to lead away the loaded pallets via the second region in the same direction. Preferably, for this, the carrier construction has passages with a clear height, which is adapted to the height of empty pallets, including the height of a pallet conveyor device. The invention permits the avoidance of voluminous overhead constructions and in the case that overhanging carrier/support elements are applied for reasons of statics, these are preferably arranged in the vicinity of the base.

Preferably, the carrier construction comprises at least one vertically orientated carrier column and at least one carrier arm which is arranged overhanging thereon, wherein the at least one holding element is arranged on the carrier arm. The at least one holding element may be positioned above the working base surface, e.g. by way of the at least one carrier arm being movable and/or the holding element being moved relative to the carrier construction. It is prefereable, but not necessary, for the complete carrier construction with the exception of the at least one carrier arm, to be located laterally outside the working base surface. The usually vertical carrier column preferably has a height, which is larger than the effective palleting height (total height of the pallet plus layers of product units plus any pallet transport device).

Particularly preferably, the palleting device includes an intermediate base removal element, which is arranged on the carrier construction and may be displaced essentially synchronously with the at least one holding element. It serves for removing a flexible intermediate base or another separating element, in particular a paper web, a cardboard web or a film, from an intermediate base storage, e.g. a carriage, and positioning it below the printed product unit before depositing this. Such intermediate bases are applied when a layer of several stacks has been created on the pallet in a completed manner, in order to separate the different layers from one another. Likewise, such an intermediate base may be arranged between the pallet and the first layer. The intermediate base removal element is, for example, a suction element or gripper element arranged on the holding element and is controlled in a suitable manner, in particular with the same control device as the holding elements.

The holding elements may be grippers, which for example, receive a stack preferably in its longitudinal direction in a clamping manner. Holding elements in the form of blades or forks may also be applied for gripping and transporting smaller units, e.g. stacks of products lying on one another, and these blades or forks support the product units from below. Preferably, two holding elements which cooperate with one another and which are arranged at a variable distance to one another are present, which are capable of receiving a printed product unit, in particular a stack, between them in a clamping manner.

The processing system according to the invention includes a device for forming strapped units of printed products, e.g. a stack feeder, and at whose exit an intermediate deposit and a palleting position is located, as well as the already described palleting device, which is capable of receiving the printed product units from the intermediate deposit. Preferably, the processing system includes a conveyor device for the pallets, e.g. a roller carpet. The conveyor path of the pallet conveyor device is preferably straight and runs particularly preferably essentially perpendicularly to the transport direction of the printed product units within the working base surface, i.e. parallel to the unit formation device, which permits a relatively space-saving arrangement. A further preferred embodiment envisages the empty pallets being supplied perpendicularly to the transport direction of the printed product units and being transported away parallel to this after being loaded. One example of a unit formation device in the form of a stack feeder is described in WO 2004/009448.

The processing system is preferably controlled by a common control device, e.g. a logistics module, which may be realised by way of suitable software. For this, condition information and control signals are exchanged between the control device and different suitable sensors and the participating system components. The control device, for example, by way of suitable sensors (camera, weight sensor), monitors the deposit space on the intermediate deposit and, at latest on reaching its maximal capacity, ensures the further transport of the product units (e.g. stacks) to the pallet by way of the palleting device, or an interruption of the unit formation (stack formation). The control device, moreover, monitors the loaded condition of the pallet, e.g. likewise by way of a camera, and controls the movement of the palleting device in a manner such that a new product unit is deposited at a suitable location on the pallet. If a layer is complete, the control device causes an intermediate base to be removed from the storage and be arranged on the completed layer. This is preferably effected simultaneously with the gripping and depositing of the first product unit of a new layer. Finally, the loading condition of the pallet is monitored, and on reaching its maximal capacity, causes its transport away as well as the feeding of an empty pallet. The control may also be integrated into a higher-ranking logistics control, which creates the management and movement of empty and loaded pallets, the resupply to intermediate bases by way of the exchange or filling of the respective storage, and the control of the subordinate processes such as e.g. further processing, commissioning, dispatch of the product units, etc. Individual or all part processes, e.g. gripping of a product unit by the palleting device, exchange of a full pallet for an empty pallet, may also be activated manually by an operating person or completely controlled depending on the demands. The overriding logistics control, inasmuch as is present, is informed of this, preferably by way of exchange of suitable control signals, so that the remaining processes may be adapted to this.

### BRIEF DESCRIPTION OF THE DRAWINGS

Examples of the invention are represented in the drawings and described hereinafter. There are shown in a purely schematic manner:

FIG. 1 a total view of a processing system according to the invention;

FIG. 2 a palleting device according to the invention;

FIGS. 3-5 various views of the palleting device of FIG. 2 with a loaded pallet in the palleting position;

FIG. 6 the palleting device of FIG. 2, with a conveyor device for pallets.

### DETAILED DESCRIPTION OF THE INVENTION

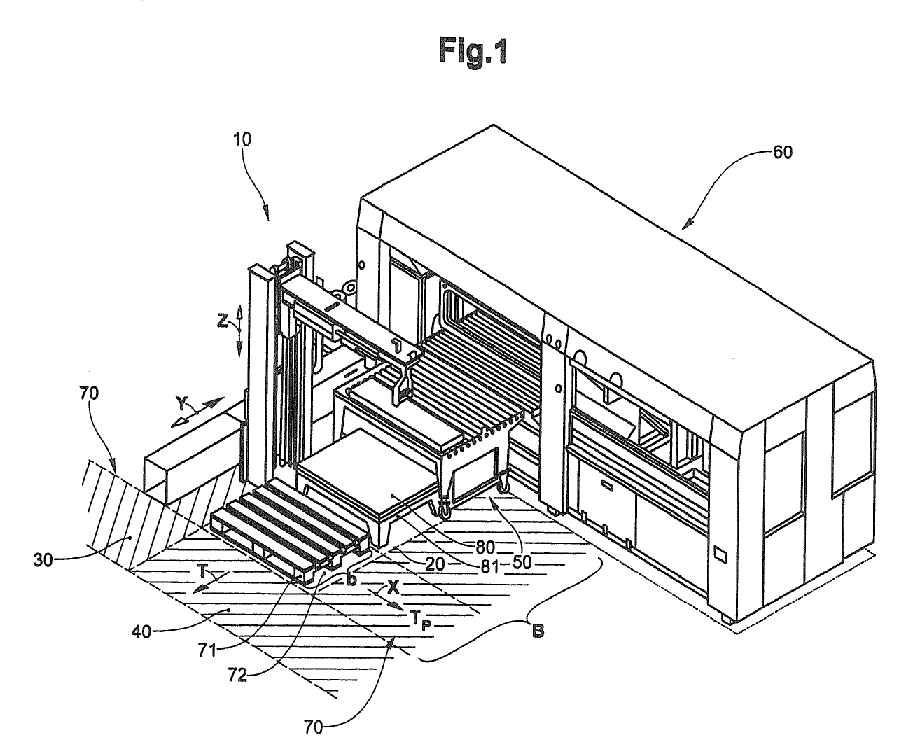

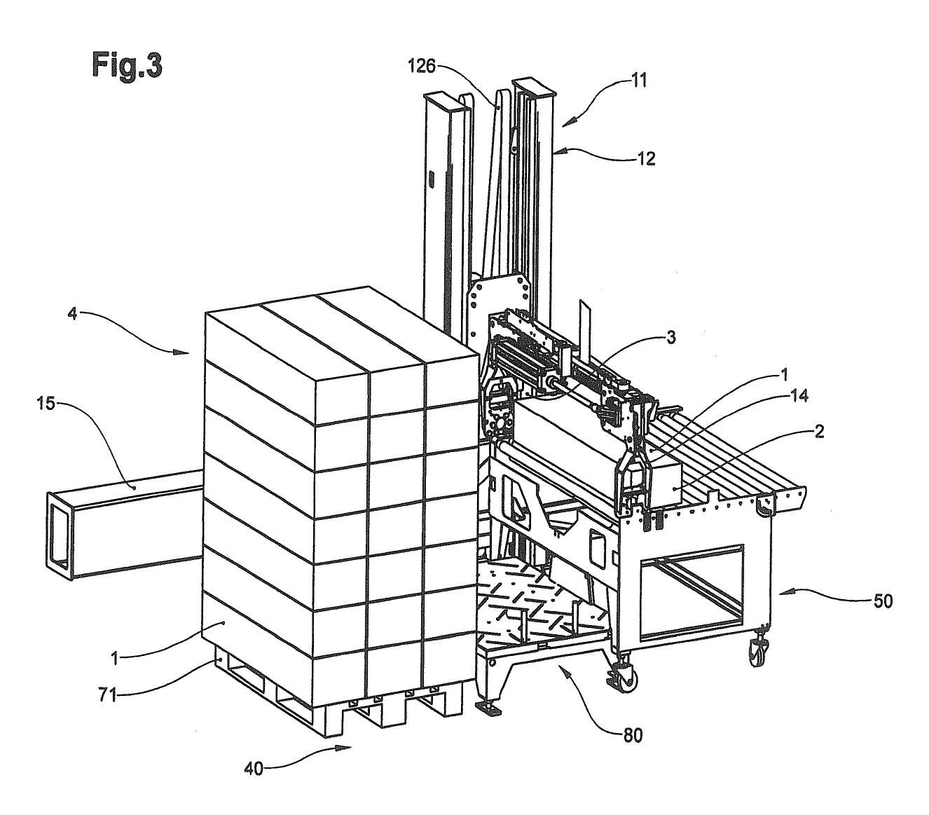

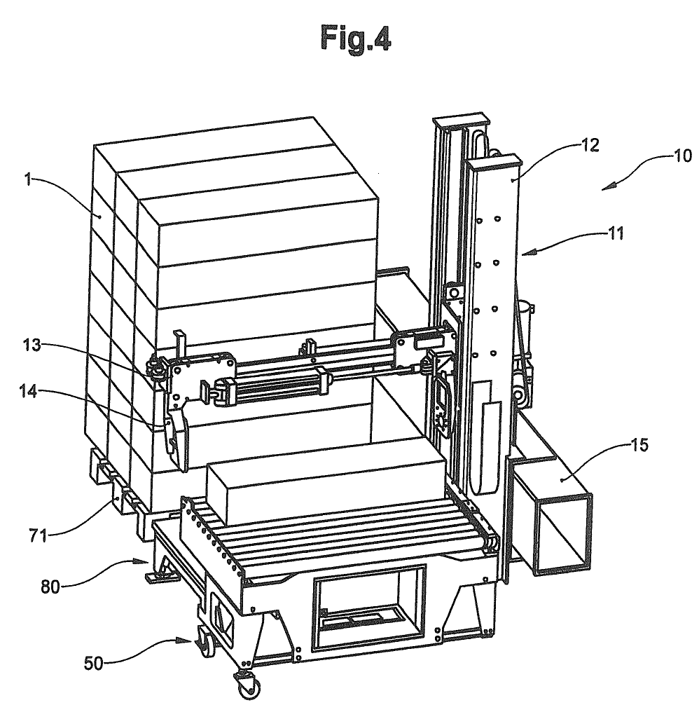

FIG. 1 shows a total view of a processing system according to the invention, which as main components comprises a palleting device 10, a unit formation device 60, here a stack feeder, an intermediate deposit 50 arranged at its exit, and a pallet conveyor device 70. The products are fed individually to the stack feeder and there are grouped together into a product unit which is not represented, in the form of a stack 1 (see FIG. 3-6). This leaves the stack feeder 60 in a transport direction T running transversely to its longitudinal direction and gets to the intermediate deposit 50, here in the form of a carriage with a preferably slightly sloping roller carpet as a rest surface. The palleting device 10 has the task of transporting the rods 1 further in the transport direction T to a palette 71, and depositing them thereon in layers 4. The pallet 71 for this is located on the pallet conveyor device 70 at a palleting position 72. The pallet conveyor device 70 conveys the pallets 71 in a pallet transport direction T_{P} which here runs perpendicularly to the stack transport direction T.

In a plan view from above, the pallets 71 or their outline and the intermediate deposit 50 span a roughly rectangular working base surface 20, within which the units 1 may be moved through the palleting device 10. An intermediate storage 80 for intermediate bases is located in the transport direction T between the pallet 71 or the palleting position 72 and the intermediate deposit 50. The intermediate deposit 50 may also be located within the stack feeder 60. A first and a second side region 30, 40 respectively are located on the left and right of the working base surface 20, seen in the transport direction T. The carrier construction 11 is located in the first side region 30, whereas the second side region is also free to the top, with the exception of the pallet conveyor device 70.

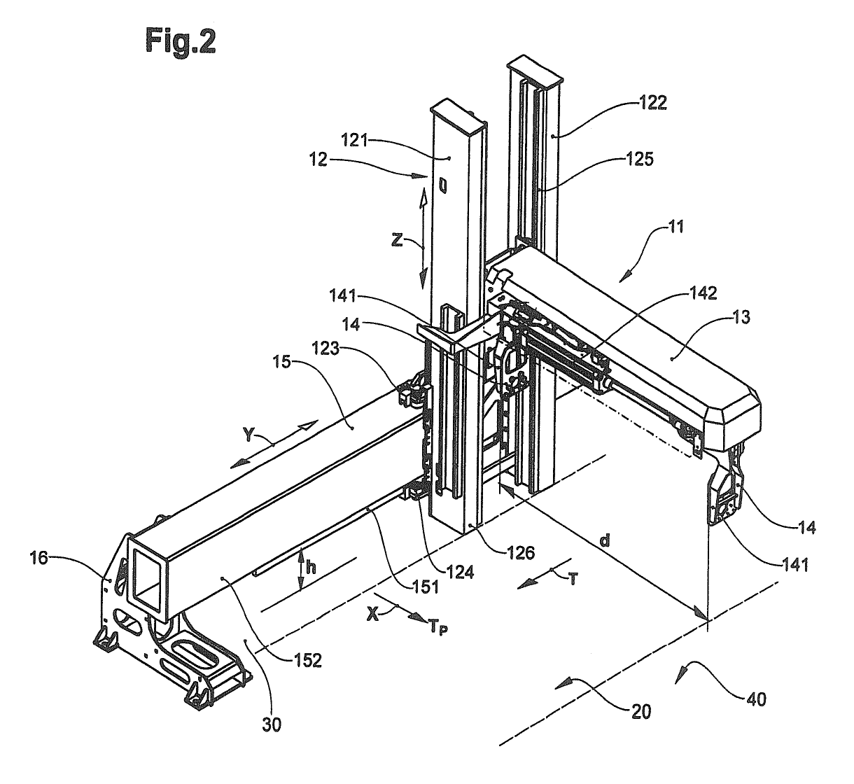

The palleting device 10 is explained in more detail with reference to FIGS. 2-6, which show the different views of the palleting device 10. The palleting device 10 comprises a carrier construction 11, which here comprises a vertical carrier column 12 with two parallel side parts 121, 122. This is displaceably mounted in the horizontal (y-direction) on a horizontally orientated carrier 15. The alignment of the carrier 15 (y-direction) corresponds to the transport direction T of the stacks 1. For this, the carrier 15 comprises one or more guide rails 151, which cooperate with guide elements 123, 124 on the carrier column 12. The carrier 15 is mounted 16 in such a raised manner, that its lower side 152 facing the base has a distance h from the base. The support elements 16 may be anchored in the base. They may be longitudinally extended transversely to the axis of the carrier 15, in order to increase the stability. The support 15 has a hollow profile with, for example, a rectangular cross section and is as torsionally stiff as possible.

A laterally projecting holding arm 13 is mounted in a height-adjustable manner (z-direction) on the carrier column 12. Two pairs of vertically running guide rails 125 in which the holding arm 13 runs, serve for an as tilt-free as possible vertical movement of the holding arm 13. The holding arm is moved by way of its own drive, wherein the force transmission is effected, for example, via belts (see FIG. 3). The holding arm 13 has a length which corresponds essentially to a typical stack length. At its two ends, it carries in each case a holding element 14 with essentially plane holding surfaces 141 which face one another. The distance d of the holding elements 14 may be set e.g. by way of the movement of one of the holding elements 14 by way of a hydraulic/pneumatic cylinder or a motor (e.g. linear motor, electric motor) 142, so that a stack 1 may be gripped in the manner of a pincer.

The working base surface 20 of the palleting device 10 is here defined by the region which the carrier arm 13 or the holding elements 14 covers/cover on movement of the carrier columns in the y-direction. The intermediate deposit 50 and the pallet 71 are arranged relative to the palleting device 10, in a manner such that they are located within the working base surface 20. Within the working base surface 20, the products units in the present example are only displaced in the y-direction and z-direction, but with a suitable design of the holding system, a horizontal movement perpendicular to the transport direction T (x-direction) and/or rotation is possible, e.g. in order to rotate the stacks 1 before deposition, and to deposit them with a different alignment.

According to the invention, the carrier construction 11 is arranged in the first side region 30, here the left of the working base surface 20. Only the carrier arm 13 is located above the working base surface 20. No elements of the carrier construction 11 are arranged in and above the second side region 40, which here lies opposite the first side region 30 with respect to the transport direction T (y-direction). Due to this, the working base surface 20 is freely accessible without height limitation or elements close to the base, at least via the second side region 40. The second side region 40 has a width B, which is larger than the width b of a pallet 71, and here, the width B is larger than the combined widths of the pallet 71, the vehicle 80 and the intermediate deposit 50. The carrier 15 is arranged parallel to a side edge of the working base surface or parallel to the transport direction T of the product units 1 from the intermediate deposit 50 to the palleting position 72.

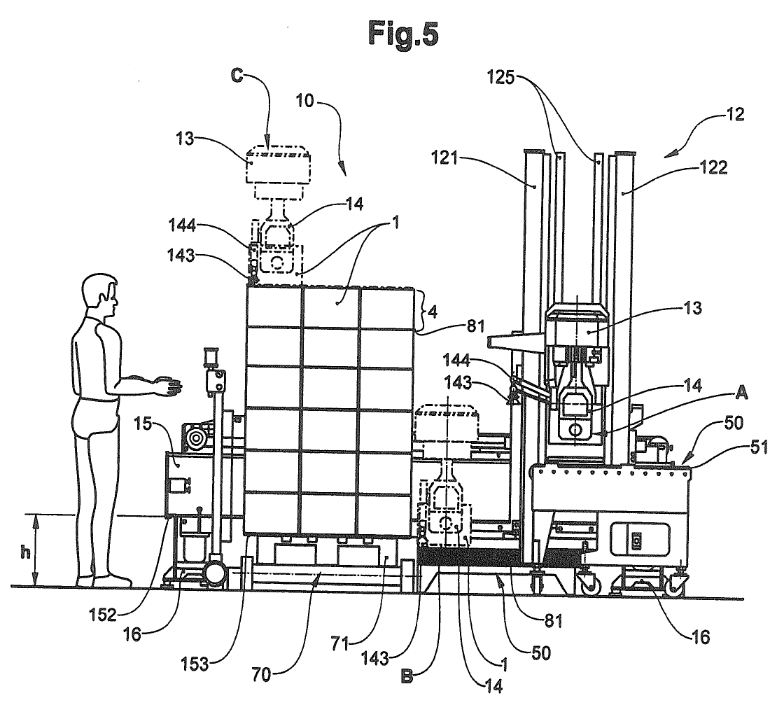

The manner of functioning of the device is explained hereinafter: FIG. 2 shows the palleting device 10 with the carrier column 10 in its front end position which faces the stack feeder 60, along the horizontal carrier 15. The carrier arm 13 is lowered to a height, which corresponds roughly to the height of the intermediate deposit 50. This is also shown in FIG. 5 in the position of the carrier arm 13 above the intermediate deposit 50, said position being indicated at “A”. The holding elements 14 are made to approach the two axial end regions 2, 3 of a stack 1 from the outside, for receiving the stack 1, and the stack 1 is received between these in a clamping manner by way of reducing the distance d of the holding elements 14. The holding arm 13 is thereupon moved away from the intermediate deposit 50, e.g. by way of movement in the z-direction and/or in the y-direction. By way of displacing the carrier column 12 along the carrier 15, the stack 1 is moved to the palleting position 72 (position “C” in FIG. 5). The height is thereby adapted to the momentary loading height on the pallet 71 by way of travelling the carrier arm 13 along the carrier column 12, and the stack 1 is deposited at a suitable position on the pallet or on stacks already deposited thereon. The carrier column 12 is subsequently travelled again to the intermediate deposit 50.

For reasons of stability, it is advantageous if individual layers 4 of stacks 1 are separated from one another by intermediate bases 81, e.g. of a flexible web material. These intermediate bases 81 lie as a stack on the intermediate base storage 80, which here is designed as a carriage. The carrier construction 11, for removal and transport of the intermediate bases 81, comprises at least one intermediate base removal element 143, e.g. a gripper or a suction element. This serves for the withdrawal of the intermediate base 81 from the stack and positioning it below the printed product unit during or before the deposition of this. Additional to and fro movements for adding the intermediate bases 81 are avoided by way of the removal element 143 being moved synchronously with the holding elements 14.

As FIG. 5 shows, the intermediate base removal element 143 is arranged on the carrier arm 13 and for this reason is moved by the movement of the carrier arm in the y-direction and z-direction synchronously to the holding arms 14. The intermediate base removal element 143 is connected to the carrier arm in a pivotable manner via a lever 144, here a double lever, about an axis parallel to the carrier arm. In the idle condition, i.e. when it is not used, it is pivoted into a lateral position, so that its active surface, here the openings of the suction elements used for receiving the intermediate bases, is located above the plane defined by the holding elements 14. This is shown in FIG. 5 in the position of the carrier arm 13 above the intermediate deposit 50, said positions being indicated at “A”. For receiving an intermediate base 81, the lever 144 is pivoted into a largely perpendicular orientation. This is shown in FIG. 5 in the position of the carrier arm 13 indicated at “B”, directly above the intermediate storage 80. The holding elements 14 at this point in time have already received a stack 1. The intermediate base 81 and stack 1 are subsequently moved by way of a movement of the carrier arm 13 in the y-direction and z-direction, into the release position “C” above the pallet or the stacks 1 already deposited thereon. The intermediate base 81 is applied onto a completed layer 4, and simultaneously the first stack 1 of the new layer is deposited. The position “B” is not moved to by the carrier arm 13, in the case that no intermediate base 81 is to be introduced.

As FIG. 5 shows, the storage 80 for the intermediate bases 81, e.g. a roller carriage/roller table, may also be arranged partly below the deposit surface 51 of the intermediate deposit 59, in a plan view from above. The intermediate base removal elements 143 merely need to be able to engage onto the end of the intermediate bases 812, which is at the front in the transport direction. A space-saving arrangement is realised by way of this.

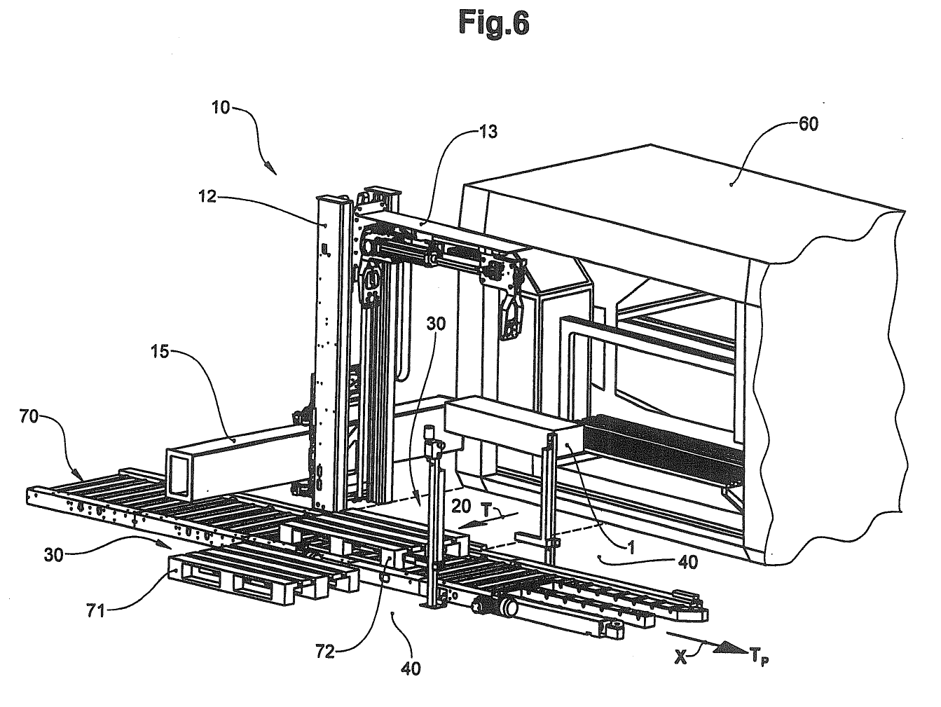

If the pallet 71 is fully loaded, it is transported away in the pallet transport direction T_{P}. The pallet transport direction T_{P} runs in the x-direction, thus perpendicularly to the rod transport direction T. The pallet conveyor device 70 which is used for this, as shown in FIG. 6, is for example a roller carpet. This is orientated parallel to the longitudinal direction (stack formation direction) of the stack feeder 60. Since no components of the carrier construction 11 are arranged in the transport direction T_{P} of the loaded pallet 71, specifically through the second side region 40, the loaded pallet 71 may be transported away without any mechanical hindrance by any carrier/support parts. As already described, the lower side 152 of the carrier 15 is arranged at a distance h to the base. An empty pallet 71 on the conveyor device 70 may be conveyed below the carrier 15 to the palleting position 72, through the thus formed passage 153. The passage for this has at least the width of a pallet 71 transverse to its conveyor direction T_{P} and a height h which corresponds to the height of the conveyor device 70 plus the height of the pallet 71. Preferably, the lower side 126 of the carrier column 12 is likewise distanced to the base, wherein the distance corresponds at least to the height of the conveyor device 70, so that the carrier column 12 may travel over this with a movement along the carrier 15. The movement of the pallet 71 is effected always in the same direction T_{P}, and no complicated deflections within the pallet conveyor path are necessary.

Instead of a feed-conveying and conveying-away of the pallets in the pallet transport direction T_{P}, the loaded pallets may also be conveyed away in the stack transport direction T. Since then no elements are arranged close to the base in the second side region 40, once again an improved accessibility of the intermediate deposit 50 or the stack formation device 60 results.

A control device, which is not shown here, monitors the status of the different system components by way of suitable sensors, and controls their movements. In particular, it ensures that the stacks are deposited to a suitable location, the empty and loaded pallets are fed and led away respectively, and the intermediate bases are gripped and inserted. The control of these and other part processes may also be effected manually by an operating person. The control device may be part of a central control system, e.g. of a central logistics control.

The following modifications of the represented device may, for example, likewise be applied:

Instead of moving the carrier arm 13 in the z-direction, the holding elements 14 may be adjusted in height relative to this. They may, for example, also be rotatable about a vertical axis, in order to rotate the stack as a whole, e.g. for depositing onto the pallet in a different orientation. Likewise, the holding elements 14 may be rotatable or pivotable about an axis running in the x-direction.

The holding elements 14 may also be designed in the manner of a blade with a horizontal rest surface. One may engage below smaller units, e.g. stacks of lying products and these supported from below, with such holding elements.

Alternatively, to the linear travel of the carrier column 12 along the carrier 15, this may also be stationary. The carrier column 12 itself or a holding arm attached thereto may for example be rotated or pivoted about the axis of the carrier column 12, for the transport of the product units within the working base surface.

The carrier column 12 does not need to project upwards, but may also be set obliquely or have an angle course.

Instead of holding elements on a carrier arm, a robot accessing the working base surface on one side may be present, which may grip the product units, move them from the intermediate deposit to the stack and may deposit them there in a suitable manner.

Instead of a single carrier column, one may also use a carrier construction with several carrier columns. This for example, as with the state of the art, forms a portal-like carrier frame with a transverse connection, along which the holding elements or an overhanging arm may be displaced. In contrast to the state of the art, the base surface of the carrier construction used here for the at least one holding element is here located laterally of the intermediate deposit, which is thus accessible from the other side The outline of the carrier construction is preferably located only in a side region of the working base surface and no components of the carrier construction are located above the other side region.

Basically, not only the movable carrier arm, but the carrier frame per se may be designed in a laterally overhanging manner, and in this case, parts thereof may be arranged above the working base surface. However no parts of the carrier frame are located above a lateral region next to the working base surface, so that here one may operate without any height limitation.

1. A palleting device for the transport of units of printed products, which are held together by way of strapping, in particular of stacks which are formed from printed products which are rowed on one another in a standing manner or of packages of printed products applied on one another in a lying manner, within a working base surface, the palleting device comprising:
a working base surface accommodating an intermediate deposit and a palleting position;
a first side region laterally outside of the working base surface;
a second side region laterally outside of the working base surface and opposite to the first side region;
a carrier construction with at least one vertically and horizontally displaceable holding element, which is capable of taking at least one printed product unit from the intermediate deposit and transporting it to the palleting position;
wherein the carrier construction, in the plan view from above onto the working base surface, is arranged essentially within the working base surface and/or in the first side region, wherein the second side region of the working base surface is free of the carrier construction.

2. A palleting device according to claim 1, wherein the carrier construction in the first side region is distanced at least partially from the base, in a manner such that a pallet may be guided through the first side region to the working base surface.

3. A palleting device according to claim 1, wherein the second side region has a width, which is larger than the width of a pallet.

4. A palleting device according to claim 1, wherein the carrier construction comprises at least one vertically orientated carrier column and at least one carrier arm which is arranged thereon in an overhanging manner, wherein the at least one holding element is arranged on the carrier arm.

5. A palleting device according to claim 4, wherein the carrier construction comprises a horizontal carrier arranged in the proximity of the base, which at least partially is distanced to the base in a manner such that a pallet may be guided through below the carrier.

6. A palleting device according to claim 5, wherein the carrier column is displaceably mounted on the horizontal carrier in the horizontal direction.

7. A palleting device according to claim 5, comprising a pallet conveyor device, which leads through the first side region and below the carrier to the working base surface.

8. A palleting device according to claim 7, wherein the pallet conveyor device comprises a roller carpet.

9. A palleting device according to claim 3, wherein the carrier arm is movable relative to the carrier column.

10. A palleting device according to claim 9, wherein the carrier arm is adjustable in height and/or is pivotable about the axis of the carrier column.

12. A palleting device according to claim 3, wherein the at least one holding element is displaceable in the longitudinal direction of the carrier arm.

13. A palleting device according to claim 12, wherein the at least one holding element is pivotable about an axis running parallel to the carrier arm

14. A palleting device according to claim 1, comprising at least one intermediate base removal element, which is arranged on the carrier construction, is displaceable essentially synchronously with the at least one holding element and is capable of removing a flexible intermediate base out of an intermediate base storage and of positioning it below the printed product unit during or before depositing this.

15. A processing system, comprising:
a device for forming strapped units of printed products with an intermediate deposit located at an exit of the device for forming strapped units;
a palleting position;
a palleting device, which is capable of receiving the printed product units from the intermediate deposit and conveying them to the palleting position, the palleting device comprising:
a working base surface accommodating the intermediate deposit and the palleting position;
a first side region laterally outside of the working base surface;
a second side region laterally outside of the working base surface and opposite to the first side region;
a carrier construction with at least one vertically and horizontally displaceable holding element, which is capable of taking at least one printed product unit from the intermediate deposit and transporting it to the palleting position;
wherein the carrier construction, in the plan view from above onto the working base surface, is arranged essentially within the working base surface and/or in the first side region, wherein the second side region of the working base surface is free of the carrier construction.

16. A processing system according to claim 15, comprising a pallet conveyor device for unloaded or loaded pallets with a straight conveyor path, which runs through the first side region, the working base surface and the second side region.

17. A processing system according to claim 15, wherein the carrier construction comprises at least one vertically orientated carrier column, which is displaceably mounted in the horizontal direction on a carrier which is arranged horizontally, in the proximity of the base, wherein the carrier at least partially is distanced to the base and the conveyor device is led through below the carrier.

18. A processing system according to claim 16, wherein the conveyor path of the pallet conveyor device runs essentially perpendicularly to a transport direction of the printed product units within the working base surface.

19. A processing device according to claim 15, comprising a control device which is capable of controlling the palleting device and/or the device for forming strapped units of printed products and/or further system components which are present as the case may be, in dependence on one another.

20. A processing device according to claims 16, comprising a control device which is capable of controlling the palleting device and/or the device for forming strapped units of printed products and/or the pallet conveyor device, and/or further system components which are present as the case may be, in dependence on one another.

21. A processing system according to claim 19, wherein the control device is capable of evaluating signals of suitable sensors and/or condition information of the participating system components and producing control signals in dependence thereon, and transferring them to the participating system components, which influence the condition of the participating system components in dependence on one another.
